(19) United States
(12) Patent Application Publication
(10) Pub. No.: US 2022/0195877 A1
(43) Pub. Date: Jun. 23, 2022

(54) ROTOR DISK AND ROTOR BLADE FOR A GAS TURBINE COMPRESSOR OR TURBINE STAGE OF AN AEROENGINE

(71) Applicant: MTU Aero Engines AG, Munich (DE)

(72) Inventor: Hermann NACHTIGALL, Munich (DE)

(21) Appl. No.: 17/552,670

(22) Filed: Dec. 16, 2021

(30) Foreign Application Priority Data
Dec. 21, 2020 (DE) 102020216436.3

(51) Int. Cl. F01D 5/30; F01D 5/14; B23H 9/10

(52) U.S. Cl. CPC F01D 5/3007; F01D 5/147; B23H 9/10; F05D 2230/11; F05D 2300/516; F05D 2250/141; F05D 2250/294; F05D 2260/36; F05D 2240/31

(57) ABSTRACT

A method for producing a rotor disk or a rotor blade for a gas turbine compressor stage or turbine stage of an aeroengine, wherein at least one blade groove of the rotor disk for arrangement of a blade foot of a rotor blade for fastening the rotor blade to the rotor disk, or a blade foot of the rotor blade for arrangement in a blade groove of a rotor disk for fastening the rotor blade to the rotor disk is fabricated using an electrochemical material removal and in the axial direction has a profile which is curved once or more.

### CROSS-REFERENCE TO RELATED APPLICATIONS

The present application claims priority under 35 U.S.C. § 119 of German Patent Application No. 102020216436.3, filed Dec. 21, 2020, the entire disclosure of which is expressly incorporated by reference herein.

### BACKGROUND OF THE INVENTION

### 1. Field of the Invention

The present invention relates to a rotor disk and a rotor blade for a gas turbine compressor stage or turbine stage of an aeroengine, an aeroengine gas turbine and a compressor stage or turbine stage therefor having the rotor disk and/or rotor blade, and a method for producing the rotor disk or rotor blade.

### 2. Discussion of Background Information

According to in-house practice, blade grooves are fabricated in rotor disks for aeroengine gas turbines and rotor blades are then inserted by their blade feet into said grooves in order to obtain a bladed rotor.

Due to the component quality that is necessary for aeroengines, in particular due to their safety requirements and dynamic and thermal loads, these blade grooves have been produced, until now and in accordance with in-house practice, by means of reaming.

As a result of blade grooves and blade feet which in the axial direction have a curved, for example circle segment-shaped profile, a contact area could advantageously be enlarged with the same disk or blade foot thickness, thus reducing the load, or, conversely, with the same load the disk or blade foot thickness and thus weight could be reduced, which is of particular importance for aeroengines.

Such curved blade grooves, however, cannot be fabricated by means of reaming. Correspondingly, it is also not possible to fabricate curved blade feet.

For the above reasons, it would therefore be advantageous to be able to improve aeroengine gas turbines and/or the production of rotor disks and/or blade feet therefor.

### SUMMARY OF THE INVENTION

The present invention provides a method, a rotor disk produced by a method described here, and a rotor blade produced by a method described here having the features described in independent claims. Also provided are an aeroengine gas turbine and compressor stage or turbine stage therefor comprising at least one rotor disk described here or produced by a method described here and/or at least one rotor blade described here or produced by a method described here. Advantageous embodiments of the invention are the subject of the dependent claims.

In accordance with an embodiment of the present invention, a rotor disk for a compressor stage or turbine stage of an aeroengine gas turbine or a rotor disk of at least one compressor stage and/or a rotor disk of at least one turbine stage for an or of an aeroengine gas turbine has one or more blade grooves, which are distributed in particular in a circumferential direction and in which (in each case) there is arranged, in one embodiment inserted, in particular pushed in, a blade foot of a rotor blade, the rotor blade thus being secured to the rotor disk or being intended, in particular configured and/or used for this purpose.

In accordance with one embodiment of the present invention, this blade groove or one or more, preferably all, of these blade grooves has (in each case) in the axial direction a profile which is curved once or more.

Additionally or alternatively, in accordance with one embodiment of the present invention, the blade foot of at least one rotor blade for a gas turbine compressor stage or turbine stage of an aeroengine or the blade foot of at least one rotor blade of at least one compressor stage and/or the blade foot of at least one rotor blade of at least one turbine stage for an or of an aeroengine gas turbine has (in each case) in the axial direction a profile which is curved once or more, wherein the blade foot is arranged, in one embodiment is inserted, in particular pushed in, in a blade groove of a rotor disk, in one embodiment of a rotor disk described here or a rotor disk produced by a method described here, and thus secures the rotor blade to the rotor disk or is intended for this purpose, in particular is configured or is used for this purpose.

In one embodiment, the blade groove and blade foot which can be secured, in particular is secured therein, in one embodiment which can be pushed in, in particular is pushed in, have at least partially congruent or complementary contours, in particular flanks, in one embodiment (with) protrusions and recesses engaging interlockingly with one another in the circumferential direction. In one embodiment, the securing of the rotor blades to the rotor disk can hereby be improved.

An axial direction, in one embodiment, is parallel to a rotation or (main) machine axis of the compressor stage or turbine stage or aeroengine gas turbine, a circumferential direction is correspondingly a rotation direction about this rotation or (main) machine axis, and a radial direction is a direction perpendicular to the axial and circumferential direction or direction (axis) which intersects this rotation or (main) machine axis perpendicularly, in particular (points) away therefrom.

A profile which is curved in the axial direction can be characterized in particular in that the cross sections of the blade groove or of the blade foot, in two sections spaced axially from one another by a distance, perpendicularly to the axial direction, in particular their centers of mass, center lines, possibly symmetry lines and/or mutually corresponding, in particular congruent contour portions, are offset relative to one another in the circumferential direction by a first angle, and two other sections spaced axially from one another by the same distance, perpendicularly to the axial direction, in particular their centers of mass, center lines, possibly symmetry lines and/or mutually corresponding, in particular congruent contour portions, are offset relative to one another in the circumferential direction by a second angle, which is different from the first angle.

A profile which is curved more than once in the axial direction can be characterized in particular in that the profile has a plurality of different curvatures, in one embodiment at least two oppositely directed curvatures and/or at least two curvatures (radii of curvature) of different absolute value. A profile which is curved once in the axial direction can be characterized in particular in that the profile has a single curvature or the same curvature throughout.

In one embodiment, due to the blade grooves or feet which have a curved profile in the axial direction, it is advantageously possible, as explained in the introduction, to increase contact areas between rotor disk and rotor blades (rotor blade feet) with the same disk or foot thickness and thus to reduce the load, and/or to reduce the disk or foot thickness and thus weight, which is of particular importance for aeroengines.

In accordance with one embodiment, the blade groove can run partially or fully over its cross section continuously in the axial direction through the rotor disk. The disk humps arranged between the disk grooves can thus be separated and/or decoupled in respect of stress in the circumferential direction, which can be advantageous for the service life.

The present invention also comprises a blade which is complementary to this embodiment, the axial blade foot faces of which blade are partially or fully exposed axially on both sides when the blade is inserted into the blade groove.

In accordance with one embodiment of the present invention, it is now proposed that the rotor disk blade groove curved once or more in the axial direction or one or more, preferably all, of the blade grooves curved once or more in the axial direction is/are manufactured, in one embodiment successively with use of a single-stage or multi-stage electrochemical material removal or ECM (Electro Chemical Machining) method.

In accordance with one embodiment of the present invention, it is additionally or alternatively proposed that the blade foot, curved once or more in the axial direction, of the rotor blade or of one or more rotor blades is/are fabricated (in each case) using a single-stage or multi-stage electrochemical material removal or ECM method.

The blade groove(s) or feet, in one embodiment, can thus be fabricated particularly advantageously in particular with advantageous contours and/or profiles in the axial direction and/or surfaces and/or low(er) stresses and/or without post-processing.

In a particularly preferred embodiment, the or an electrochemical material removal or ECM method used to produce the blade groove(s) and/or the or an electrochemical material removal or ECM method used to produce the blade feet comprises an oscillating cathode movement and a pulsed electrical current (Precise Electrochemical Machining, PECM).

The blade groove(s) or feet, in one embodiment, can thus be produced particularly advantageously, in particular with advantageous contours and/or profiles in the axial direction and/or surfaces and/or low(er) stresses and/or without post-processing.

Additionally or alternatively, in a particularly preferred embodiment, the or an electrochemical material removal or ECM method used to produce the blade groove(s) and/or the or an electrochemical material removal or ECM method used to produce the blade feet comprises a pulsed current supply with continuous cathode movement (Pulsed Electrochemical Machining, pulse ECM).

The blade groove(s) or feet, in one embodiment, can thus be produced particularly advantageously, in particular with advantageous contours and/or profiles in the axial direction and/or surfaces and/or low(er) stresses and/or without post-processing.

In one embodiment, the or an electrochemical material removal or ECM method used to produce the blade groove(s) and/or the or an electrochemical material removal or ECM method used to manufacture the blade feet can additionally or alternatively comprise an electrochemical micro milling or ECF method.

In one embodiment, the or an electrochemical material removal or ECM method used to produce the blade groove(s) and/or the or an electrochemical material removal or ECM method used to produce the blade feet can comprise an ECDM method (Electro Chemical Discharge Machining (method)).

The aforementioned PECM or pulse ECM methods are particularly advantageous or preferred, in particular for producing the groove and/or on account of the surfaces that can be produced or are produced with these methods.

In one embodiment, a contour of the blade groove or of one or more, preferably all, of the blade grooves is (in each case) finished at least in some portions, in one embodiment over at least 50% of a groove flank, preferably at least 50% of both groove flanks of the contour, by means of electrochemical material removal, in particular by means of ECF and/or ECDM and/or particularly preferably by means of PECM and/or pulse ECM, in one embodiment without material-removing post-processing.

Correspondingly, in one embodiment, the blade groove or one or more, preferably all, of the blade grooves has or have (in each case) a contour which is finished at least in some portions, in particular over at least 50% of a groove flank, preferably at least 50% of both groove flanks, by means of electrochemical material removal, in particular by means of ECF and/or ECDM and/or particularly preferably by means of PECM and/or pulse ECM, in one embodiment without material-removing post-processing, or has a resultant or corresponding surface, in particular surface finish.

In one embodiment, a contour of the blade foot of the or of one or more rotor blade(s) is (in each case) finished at least in some portions, in one embodiment over at least 50% of a blade foot flank, preferably at least 50% of both blade foot flanks, of the contour by means of electrochemical material removal, in particular by means of ECF and/or ECDM and/or particularly preferably by means of PECM and/or pulse ECM, in one embodiment without material-removing post-processing.

Correspondingly, in one embodiment, the blade foot of the or of one or more rotor blade(s) has or have (in each case) a contour which is finished at least in some portions, in particular over at least 50% of a blade foot flank, preferably at least 50% of both blade foot flanks, by means of electrochemical material removal, in particular by means of ECF and/or ECDM and/or particularly preferably by means of PECM and/or pulse ECM, in one embodiment without material-removing post-processing, or has a resultant or corresponding surface, in particular surface finish.

A (groove or blade foot) flank is, in one embodiment, a flank (viewed) in the circumferential direction.

In one embodiment, regions of the blade groove(s) or feet which are subject to particularly high loads, in particular bear high loads, can thus be realized particularly advantageously, in particular with advantageous profiles in the axial direction and/or surfaces and/or low(er) stresses and/or (more) quickly and/or (more) precisely.

Additionally or alternatively, in one embodiment, the blade groove or one or more, preferably all, of the blade grooves is/are (in each case) generated by means of electrochemical material removal, in particular by means of ECF and/or ECDM and/or particularly preferably by means of PECM and/or pulse ECM, in one embodiment from a solid or from a solid material and/or without material-removing post-processing.

Additionally or alternatively, in one embodiment, the blade foot of the or of one or more rotor blade(s) is/are (in each case) generated by means of electrochemical material removal, in particular by means of ECF and/or ECDM and/or particularly preferably by means of PECM and/or pulse ECM, in one embodiment from a solid or from a solid material and/or without material-removing post-processing.

In one embodiment, blade grooves or feet can thus be fabricated with advantageously low(er) stresses and/or thermal loads, and in some embodiments can be fabricated also entirely without stresses and/or thermal loads.

In another embodiment, core regions of the blade grooves and/or core regions of recesses or returns on blade feet can also firstly be produced by means of another, in particular material-removing, manufacturing process, in particular with defined or undefined cutting edges, preferably by milling or the like, and the contours can then be fabricated (finished) by means of electrochemical material removal.

In one embodiment, blade grooves or feet can thus possibly be produced (more) economically.

In one embodiment, a tool which is used for or during the electrochemical material removal to fabricate, in particular finish, the blade groove(s) or (portions of the) blade groove contours, has, in one embodiment, an electrode, in particular cathode, for electrochemical material removal and/or an electrode or cathode holder for this electrode or cathode, a curved contour, preferably corresponding to the curved profile of the blade groove(s), in particular congruent with a portion of the curved contour of the blade groove(s) in the axial direction, and/or, in one embodiment, is guided mechanically and/or automatically or by machine over a curved path, in one embodiment along the groove profile (which is desired or which is to be fabricated).

Additionally or alternatively, in one embodiment, a tool which is used for or during the electrochemical material removal to fabricate, in particular finish, the blade foot of the rotor blade or the blade feet of the rotor blades or (portions of the) blade foot contours has, in one embodiment, an electrode, in particular cathode, for electrochemical material removal and/or an electrode or cathode holder for this electrode or cathode, a curved contour, preferably corresponding to the curved profile of the blade foot, in particular congruent with a portion of the curved contour of the blade foot in the axial direction, and/or, in one embodiment, is guided mechanically and/or automatically or by machine over a curved path, in one embodiment along the foot profile (which is desired or which is to be fabricated).

In one embodiment, the blade grooves or feet can thus be produced particularly advantageously, in particular (more) quickly and/or (more) precisely.

The curved profile of the blade groove or of one or more, preferably all, blade grooves of the rotor disk in one embodiment comprises, in one embodiment is, (in each case) a circular path around a circle center point.

In one embodiment, the production and/or load introduction and/or distribution can hereby be improved.

In a refinement, the circle center point of this circular path—considered in the axial direction and/or radial direction—lies within the disk. In one embodiment, the load introduction can hereby be improved.

In another refinement, the circle center point of this circular path—considered in the axial direction and/or radial direction—lies outside the disk. In one embodiment, the production and/or load distribution can hereby be improved.

Additionally or alternatively, in one embodiment, the curved profile of the blade groove or of one or more, preferably all, blade grooves of the rotor disk runs (in each case) fully or (only) partially within a plane.

In one embodiment, the production and/or load introduction and/or distribution can hereby be improved.

In a refinement, this plane runs parallel to the axial direction. In one embodiment, the production and/or load distribution can hereby be improved.

Alternatively or additionally, this plane can run perpendicularly to the radial direction, in particular to a radial direction through the blade groove, and/or can run through the blade groove perpendicularly to a plane of the blade groove which halves the circumference. In other words, the blade groove can have a constant or substantially constant groove depth and/or the base of the groove can run parallel to this plane, which thus runs through the blade groove tangentially to the rotor disk. The blade groove can thus be bent or curved in the circumferential direction transversely to the blade groove. This allows a blade-disk connection which is particularly advantageous in respect of the stresses and with which the inclination between the contact face and the centrifugal force direction along the blade groove can remain substantially constant. In addition, an axis about which the curvature runs, in particular concentrically, can run parallel to the rotor disk plane, for example outside, inside or tangentially (to) the rotor disk, which can be particularly advantageous in respect of the method and/or system. With such a production of a plurality or all of the blade grooves, it is possible here to pass from one blade groove to the next by rotating the rotor disk plane by a corresponding amount about its rotation axis.

A further advantage lies in the possibility of forming the curvature profile of the blade foot appropriately in respect of a curvature profile in the blade leaf region, matched thereto, based thereon and/or with the same algebraic sign (i.e., also convex or concave when considered in a particular plane of section with the same orientation perpendicularly to the longitudinal axis of the blade). The blades can thus be formed in a more compact manner, with a lighter weight and with an improved flow of forces, and can be arranged and/or installed more closely to one another.

In another refinement, this plane runs at a tilt to the axial direction. In one embodiment, the load introduction can hereby be improved.

The curved profile of the blade foot of the or of one or more rotor blade(s) in one embodiment comprises, in one embodiment is, (in each case) a circular path around a circle center point.

In one embodiment, the production and/or load introduction and/distribution can hereby be improved.

Additionally or alternatively, in one embodiment, the curved profile of the blade foot of the or of one or more rotor blade(s) runs (in each case) fully or (only) partially within a plane.

In one embodiment, the production and/or load introduction and/or distribution can hereby be improved.

In a refinement, this plane runs parallel to the axial direction. In one embodiment, the production and/or load distribution can hereby be improved.

In another refinement, this plane runs at a tilt to the axial direction. In one embodiment, the load introduction can hereby be improved.

In one embodiment, the blade groove or one or more, preferably all, of the blade grooves of the rotor disk has (in each case) in the axial direction a circle segment-shaped profile for a profile in the form of a circle segment.

In one embodiment, the blade groove(s) can thus be fabricated particularly advantageously, in particular with low(er) stresses and/or (more) quickly and/or (more) precisely. Additionally or alternatively, in one embodiment, loads between the rotor disk and rotor blades (rotor blade feet) can particularly advantageously be reduced as a result.

In one embodiment, a radius R of this circle segment or of a circle segment-shaped center line of the blade groove is at least c/2 and/or at most 100c, in one embodiment at most 50c, in particular at most 30c, in one embodiment at most 20c, in a refinement at most 5c.

Additionally or alternatively, a center point of the circle segment or of a circle segment-shaped center line of the blade grooves has a distance in the axial direction from an axial center of the rotor disk of at most (R-c/2), in particular at most (R-c), in one embodiment at most (R-5c).

Here, c is an axial distance, in particular minimum, maximum or mean axial distance, between an upstream and a downstream axial end face of the blade groove.

In one embodiment, the blade foot of the or of one or more rotor blade(s) has (in each case) in the axial direction a circle segment-shaped profile or a profile in the form of a circle segment.

In one embodiment, the blade feet can thus be fabricated particularly advantageously, in particular with low(er) stresses and/or (more) quickly and/or (more) precisely. Additionally or alternatively, in one embodiment, loads between the rotor disk and rotor blades (rotor blade feet) can be reduced particularly advantageously as a result.

In one embodiment, a radius R of this circle segment or of a circle segment-shaped center line of the blade foot is at least c/2 and/or at most 100c, in one embodiment at most 50c, in particular at most 30c, in one embodiment at most 20c, in a refinement at most 5c.

Additionally or alternatively, a center point of the circle segment or of a circle segment-shaped center line of the blade foot has a distance in the axial direction from an axial center of the blade foot of at most (R-c/2), in particular at most (R-c), in one embodiment at most (R-5c).

Here, or in respect of the blade foot or circle segment-shaped profile thereof, c is an axial distance, in particular a minimum, maximum or mean axial distance, between an upstream and a downstream axial end face of the blade foot.

In one embodiment, loads between the rotor disk and rotor blades (rotor blade feet) can thus be particularly advantageously reduced in each case. In one embodiment, an upstream axial, preferably open, end face of the or of one or more of the blade groove(s), as viewed in the rotation direction, is not offset in relation to a downstream axial, preferably open, end face of this (particular) blade groove or is aligned therewith as viewed in the axial direction. In one embodiment the production can be improved as a result.

In another embodiment, an upstream axial, preferably open, end face of the or of one or more of the blade groove(s) is (in each case) offset in relation to a downstream axial, preferably open, end face of this (particular) blade groove in or against the rotation direction, in one embodiment by at most c, in particular at most c/2, in one embodiment at most c/4, wherein c is an axial distance, in particular a minimum, maximum or mean axial distance, between an upstream and a downstream axial end face of the blade groove. In one embodiment, the load distribution can be improved as a result.

Additionally or alternatively, in one embodiment, an upstream axial end face of the blade foot of the or of one or more of the rotor blade(s) is (in each case) offset in relation to a downstream axial end face of this (particular) blade foot in or against the rotation direction, in one embodiment by at most c, in particular at most c/2, in one embodiment at most c/4, wherein c is an axial distance, in particular a minimum, maximum or mean axial distance, between an upstream and a downstream axial end face of the blade groove. In one embodiment, the load distribution can be improved as a result.

In another embodiment, an upstream axial end face of the blade foot of the or of one or more of the rotor blade(s) is (in each case), as viewed in the rotation direction, not offset in relation to a downstream axial end face of this (particular) blade foot or is aligned therewith as viewed in the axial direction. In one embodiment, the production can be improved as a result.

In one embodiment, a or the upstream axial, preferably open, end face of the or of one or more of the blade groove(s) has (in each case) an axial distance in relation to a or the downstream axial, preferably open, end face of this (particular) blade groove of at least 10 mm and/or at most 100 mm, for example in the range of 35 mm to 55 mm or in the range of 20 mm to 40 mm. In one embodiment, this axial distance corresponds to a (relevant) disk thickness.

Additionally or alternatively, in one embodiment, a or the upstream axial end face of the blade foot of the or of one or more of the rotor blade(s) has (in each case) an axial distance in relation to a or the downstream axial end face of this (particular) blade foot of at least approximately 10 mm and/or at most 100 mm, for example in the range of approximately 35 mm to approximately 55 mm or in the range of approximately 20 mm to approximately 40 mm. In one embodiment, this axial distance corresponds to a (relevant) foot thickness.

In one embodiment, loads between the rotor disk and the rotor blades (rotor blade feet) can thus be reduced particularly advantageously.

In one embodiment, the or one or more of the blade groove(s) has/have (in each case), at least in some portions, in particular over at least approximately 50% of a groove flank, an average roughness value, in particular an average roughness value Ra according to DIN EN ISO 4287:2010, of at most approximately 2.0 μm in particular at most approximately 1.6 μm and in one embodiment at most approximately 0.6 μm.

Additionally or alternatively, the blade foot of the or of one or more of the rotor blade(s) has/have (in each case), at least in some portions, in particular over at least 50% of a foot flank, an average roughness value, in particular an average roughness value Ra according to DIN EN ISO 4287:2010, of at most approximately 2.0 μm, in particular at most approximately 1.6 μm and in one embodiment at most 0.6 μm.

In one embodiment, loads between the rotor disk and rotor blades (rotor blade feet) can thus be reduced particularly advantageously and/or a material-removing post-processing can be omitted.

In one embodiment, the or one or more of the blade groove(s) has/have (in each case) and/or the blade foot of the or of one or more of the rotor blade(s) has/have (in each case) in the radial direction one or more undercuts, in one embodiment a dovetail (profile or section) or fir tree profile (profile or cross section).

In one embodiment, the assembly and/or coupling of the rotor blade(s) on/to the rotor disk can thus be improved, in particular simplified and/or its reliability can be increased.

In particular on account of the thermal, aerodynamic and/or mechanical constraints, and in particular on account of the resultant materials, the present invention is particularly suitable for compressor stages, but in particular for turbine stages, of aeroengine gas turbines. Correspondingly, in accordance with one embodiment of the present invention, a compressor stage or turbine stage for an aeroengine gas turbine having at least one rotor disk and at least one rotor blade is protected, which or the blade foot of which is fastened or (for this purpose) arranged on or in (one (of the) blade groove(s) of) the rotor disk, in one embodiment interlockingly and/or with frictional engagement, wherein the rotor disk is a rotor disk described here and/or the rotor blade is a rotor blade described here.

Insofar as reference is made herein to an axial distance between axial end faces, this means in one embodiment the axial distance between axial end faces of the blade groove, when the (production of the) rotor disk or (of) the blade groove thereof is explained. Accordingly, insofar as reference is made herein to an axial distance between axial end faces, this means in one embodiment the axial distance between axial end faces of the blade foot, when the (production of the) rotor blade or (of) the blade foot thereof is explained.

In one embodiment, a circle center point, as considered in the axial direction, lies within the disk when said circle center point lies axially between an upstream and a downstream axial end face of the disk, as considered in the axial direction, outside the disk when said circle center point lies axially not between an upstream and a downstream axial end face of the disk,

as considered in the radial direction, within the disk when said circle center point lies radially inside an outer circumferential face of the disk, and

as considered in the radial direction, outside the disk when said circle center point lies radially not inside an outer circumferential face of the disk, or is equivalent or synonymous hereto in each case.

Accordingly, in one embodiment, a circle center point, as considered in the axial direction, lies within the blade foot when said circle center point lies axially between an upstream and a downstream axial end face of the blade foot,

as considered in the axial direction, outside the blade foot when said circle center point lies axially not between an upstream and a downstream axial end face of the blade foot,

as considered in the radial direction, inside the blade foot when said circle center point lies radially between a base face (facing the disk) of the blade foot and a blade leaf or radial end (facing away from the disk) of the blade foot of the rotor blade, and

as considered in the radial direction, outside the blade foot when said circle center point lies radially not between a base face (facing the disk) of the blade foot and a blade leaf or radial end (facing away from the disk) of the blade foot of the rotor blade, or is equivalent or synonymous hereto in each case. In other words, a circle center point which is arranged outside the blade foot (volume), in the sense of the present invention, can also lie inside the blade foot, as considered in the axial direction and/or radial direction, provided its axial or radial position lies correspondingly between the axial end faces of the blade foot or between a base face (facing the disk) of the blade foot and a blade leaf or radial end (facing away from the disk) of the blade foot of the rotor blade, and a

circle center point which is arranged outside the disk or the disk volume, in the sense of the present invention, can lie within the disk, as considered in the axial direction and/or radial direction, provided its axial or radial position lies correspondingly between the axial end faces of the disk or inside an outer circumferential face of the disk.

### BRIEF DESCRIPTION OF THE DRAWINGS

Further advantageous refinements of the present invention will become clear from the dependent claims and the following description of preferred embodiments. To this end, the figures show, partly in schematized form:

FIG. 1 a plan view of a lateral surface of a rotor disk according to an embodiment of the invention;

FIG. 2 a partial section of a blade groove of the rotor disk along line II-II in FIG. 1;

FIG. 3 a plan view corresponding to FIG. 1 during production of the rotor disk;

FIG. 4 the bladed rotor disk; and

FIG. 5 part of a rotor blade according to an embodiment of the present invention.

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

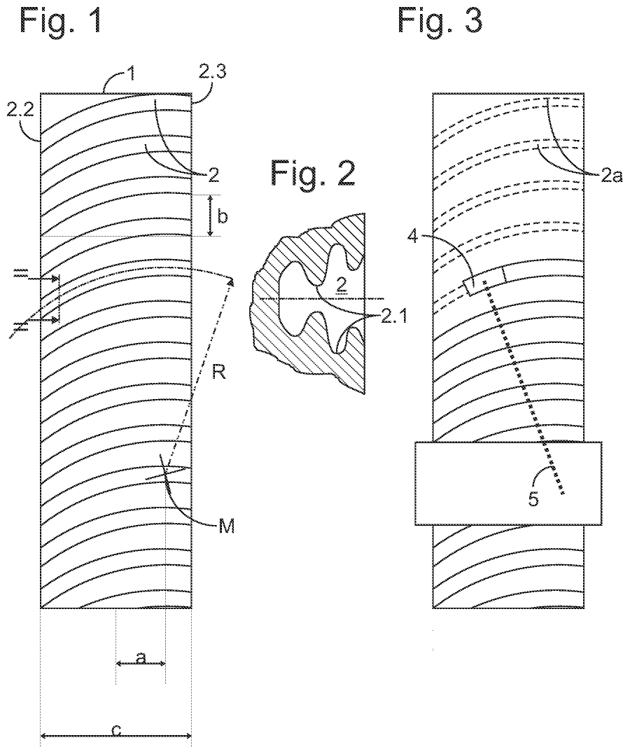

FIG. 1 shows a plan view of a lateral surface of a rotor disk 1 for a gas turbine compressor stage or turbine stage of an aeroengine according to an embodiment of the present invention.

The rotor disk 1 comprises blade grooves 2 distributed in the circumferential direction (vertically in FIG. 1) for fastening rotor blades 3 to the rotor disk, which rotor blades have a curved, circle segment-shaped profile in the axial direction (horizontally in FIG. 1), wherein a radius R of the (particular) circle segment is preferably at least c/2 and/or 100c, in particular at most 50c, in one embodiment at most 30c, in a refinement at most 20c and in one embodiment at most 5c, and/or a center point M of the circle segment has a distance a from an axial center of the rotor disk in the axial direction (in each case) of at most (R-c/2), in particular (R-c), in one embodiment at most (R-5c).

Here, c denotes the axial distance between an upstream axial end face 2.2 of a blade groove and a downstream axial end face 2.3 of said blade groove.

FIG. 2 shows, in a partial section along line II-II in FIG. 1, a cross section of one of the homogeneous(ly produced) blade grooves 2 with a fir tree profile.

To produce the rotor disks, core regions 2a of the grooves 2 can first be milled, as indicated in the upper part of FIG. 3. In a preferred embodiment, core regions 2a can also be produced additionally or particularly preferably alternatively by means of electrochemical material removal.

A tool 4, which has a curved contour corresponding to the circle segment, is then guided by means of a guide 5, which is merely symbolized very schematically, along a correspondingly curved circular path of radius R and with a center point M in order to finish the contour of the particular blade groove 2, in particular its groove flanks 2.1 (see FIG. 2) by means of electrochemical material removal. The radius R and center point M serve here merely to define the trajectory and expressly are not intended to imply a specific design of the manufacturing machine. The radius R and/or center point M in particular can be (purely) virtual.

In an alternative, particularly preferred embodiment, the blade grooves 2 can also be generated by means of electrochemical material removal, i.e., without prior milling out or electrochemical material removal of core regions 2a. In one embodiment, the fabrication time can thus be reduced. Correspondingly, in FIG. 3 the core regions 2a are shown by dashed lines in order to indicate that these or their prior forming is omitted in a particularly preferred embodiment.

The upstream axial, open end face 2.2 of the blade grooves 2 are offset in relation to the downstream axial open, end face 2.3 of the particular blade groove in the circumferential direction by b and in the axial direction have the spacing c (see FIG. 1). The axial distance, not shown separately in the drawings, between an upstream axial end face of the blade foot and a downstream axial end face of the blade foot can likewise be c, for example.

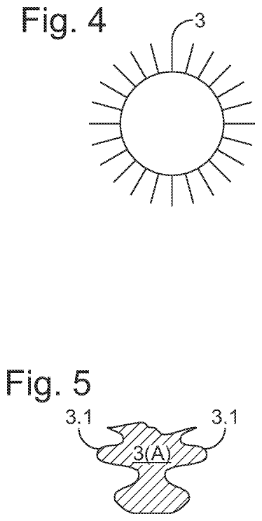

FIG. 4 shows a heavily schematized view of the rotor disk 1 fitted with blades 3 in an axial plan view.

FIG. 5 shows, in a (rotated) section corresponding to FIG. 2, part of one of the rotor blades 3 or blade foot 3A thereof with blade foot flanks 3.1.

As is the case throughout the entire disclosure, the descriptions provided in respect of the rotor disk and blade groove(s) thereof apply similarly to the rotor blade and blade foot thereof, and vice versa. Nevertheless, it is noted that the rotor disk and rotor blade aspects can also each be provided independently and therefore are expressly also claimed independently. In particular, a rotor disk described here can be fitted with rotor blades fabricated in a different way or a rotor blade described here can be fitted with a rotor disk fabricated in a different way, wherein, in particular on account of mutually corresponding surfaces and/or jointly used fabrication equipment, both aspects advantageously can be provided jointly and therefore expressly also claimed jointly.

Although exemplary embodiments have been explained in the foregoing description, it is noted that a large number of modifications are possible. In addition, it is noted that the exemplary embodiments are merely examples which are not in any way intended to limit the scope of protection, the applications, or the design. Rather, the foregoing description is intended to provide a person skilled in the art with a guideline for implementing at least one exemplary embodiment, wherein various modifications, in particular in respect of the function and arrangement of the described components, can be made without departing from the scope of protection, as is evident from the claims and feature combinations equivalent thereto.

### LIST OF REFERENCE SIGNS

1 rotor disk

2 blade groove

2a core region

2.1 groove flank

2.2 upstream blade groove end face

2.3 downstream blade groove end face

3 rotor blade

3A blade foot

3.1 blade foot flank

4 tool

5 guide (symbolic)

a axial distance between rotor disk center and center point

b distance between upstream and downstream blade groove end face in circumferential direction

c axial distance between upstream and downstream blade groove end face

M center point

R radius

1.-15. (canceled)

16. A method for producing (i) a rotor disk or (ii) a rotor blade for a gas turbine compressor stage or turbine stage of an aeroengine, wherein the rotor disk (i) comprises at least one blade groove for arrangement of a blade foot of a rotor blade for fastening the rotor blade to the rotor disk, the blade groove produced by using an electrochemical material removal and in an axial direction having a profile which is curved once or more; or wherein the rotor blade (ii) comprises a blade foot for arrangement in a blade groove of a rotor disk for fastening the rotor blade to the rotor disk, the blade foot produced by using an electrochemical material removal and in an axial direction having a profile which is curved once or more.

17. The method of claim 16, wherein the rotor disk (i) is produced.

18. The method of claim 16, wherein the rotor blade (ii) is produced.

19. The method of claim 16, wherein the curved profile has or is a circular path around a circle center point and/or runs at least in part within a plane.

20. The method of claim 19, wherein the circle center point, as viewed in an axial direction and/or radial direction, lies within the disk to be produced.

21. The method of claim 19, wherein the circle center point, as viewed in an axial direction and/or radial direction, lies outside the disk to be produced.

22. The method of claim 19, wherein the plane runs parallel to an axial direction and/or runs perpendicularly to a radial direction.

23. The method of claim 19, wherein the plane runs at a tilt to an axial direction.

24. The method of claim 16, wherein at least a portion of a contour of the blade groove of the disk to be produced or of the blade foot of the rotor blade to be produced is finished by means of electrochemical material removal and/or the blade groove of the disk to be produced or the blade foot of the rotor blade to be produced is generated by means of electrochemical material removal.

25. The method of claim 16, wherein the electrochemical material removal for fabricating the blade groove of the disk to be produced or the blade foot of the rotor blade to be produced comprises a PECM, pulse ECM, ECF and/or ECDM method.

26. The method of claim 16, wherein a tool for electrochemical material removal, for fabricating the blade groove of the disk to be produced or the blade foot of the rotor blade to be produced has a curved contour and/or is guided over a curved path, and/or the blade groove of the disk to be produced or the blade foot of the rotor blade to be produced has a circle segment-shaped profile.

27. The method of claim 26, wherein a radius of the circle segment is at least half and/or at most 100 times an axial distance between an upstream axial end face of the blade groove of the disk to be produced or the blade foot of the rotor blade to be produced and a downstream axial end face of the blade groove of the disk to be produced or the blade foot of the rotor blade to be produced and/or a center point of the circle segment has a distance from an axial center of the rotor disk to be produced or the blade foot of the rotor blade to be produced in an axial direction which is at most equal to a difference of a radius of the circle segment minus half an axial distance between an upstream axial end face of the blade groove of the disk to be produced or the blade foot of the rotor blade to be produced and a downstream axial end face of the blade groove of the disk to be produced or the blade foot of the rotor blade to be produced.

28. The method of claim 16, wherein an upstream axial end face of the blade groove of the disk to be produced or the blade foot of the rotor blade to be produced is not offset in relation to a downstream axial end face of the blade groove of the disk to be produced or the blade foot of the rotor blade to be produced is offset in or against a rotation direction and/or has an axial distance of at least 10 mm and/or at most 100 mm.

29. The method of claim 16, wherein the blade groove of the disk to be produced or the blade foot of the rotor blade to be produced has, at least in some portions, an average roughness value of at most 2.0 μm, and/or the blade groove and/or the blade foot, in a radial direction, comprises one or more undercuts.

30. A rotor disk for a gas turbine compressor stage or turbine stage of an aeroengine, wherein the rotor disk is produced by the method of claim 16.

31. The rotor disk of claim 30, wherein the blade groove runs partially or fully over its cross section continuously in an axial direction through the rotor disk.

32. A rotor blade for a gas turbine compressor stage or turbine stage of an aeroengine, wherein the rotor blade is produced by the method of claim 16.

33. A gas turbine compressor stage or turbine stage for an aeroengine with at least one rotor disk and at least one rotor blade with a blade foot, which for fastening of the rotor blade to the rotor disk is arranged in a blade groove of the rotor disk, wherein the rotor disk is a rotor disk according to claim 30.

34. A gas turbine compressor stage or turbine stage for an aeroengine with at least one rotor disk and at least one rotor blade with a blade foot, which for fastening of the rotor blade to the rotor disk is arranged in a blade groove of the rotor disk, wherein the rotor blade is a rotor blade according to claim 32.

35. An aeroengine gas turbine with at least one rotor disk and/or rotor blade produced in accordance with the method of claim 16.
